(19) United States
(12) Patent Application Publication
(10) Pub. No.: US 2011/0307130 A1
(43) Pub. Date: Dec. 15, 2011

(54) SELECTABLE DRIVING MODES

(75) Inventors: Philippe Hart Gow, Santa Monica, CA (US); Broc William TenHouten, Santa Monica, CA (US); David Brian TenHouten, Los Angeles, CA (US)

(73) Assignee: Coda Automotive, Inc., Los Angeles, CA (US)

(21) Appl. No.: 13/104,412

(22) Filed: May 10, 2011

Related U.S. Application Data
(60) Provisional application No. 61/334,441, filed on May 13, 2010.

(51) Int. Cl. G06F 17/00

(52) U.S. Cl. 701/22

(57) ABSTRACT

Electric vehicle driving modes and methods of use thereof are described. A vehicle includes a driving mode selection unit. The driving mode selection unit can be used to select a particular driving mode from amongst a plurality of driving modes. A vehicle may be capable of using more energy in a first driving mode than in a second driving mode. A driving mode may comprise at least three vehicle system operating profiles comprising at least three of motor torque curve profile, regenerative braking level profile, electronic power steering profile, electronic stability control profile, antilock braking system profile, and top speed.

### RELATED APPLICATIONS

This application claims priority under 35 U.S.C. §119(e) to U.S. Provisional Patent Application No. 61/334,441, filed May 13, 2010, and entitled “Selectable Driving Modes,” which is incorporated herein by reference in its entirety for all purposes.

### FIELD

Aspects relate to electric vehicle driving modes and methods of use thereof and, to in particular, to driving modes selectable by a driver to select between various desired driving styles.

### BACKGROUND

Rising petroleum costs and concern about carbon dioxide pollution have led to increased interest in alternative fuel vehicles, such as hybrid vehicles and electric vehicles. Some alternative fuel vehicles allow a user to control the balance between vehicle performance (e.g., rate of acceleration) and energy efficiency (e.g., driving range) by selecting a driving mode. For example, a hybrid vehicle can be configured to have a low energy efficiency mode (e.g., sport mode) and a high energy efficiency mode (e.g., economy mode), where the energy efficiency is controlled by varying the ratio of internal combustion engine use to electric motor use during vehicle acceleration. However, modes and methods for energy efficiency in electric vehicles are not well-developed.

### SUMMARY

In one aspect, a vehicle is provided. The vehicle comprises a driving mode selection unit and a plurality of driving modes, each associated with at least three vehicle system operating profiles, wherein a driving mode is operable based on input from the driving mode selection unit, wherein the at least three vehicle system operating profiles is selected from a group comprising torque command curve, regeneration braking level, steering assist level, stability control operation, antilock braking operation, and top speed of the vehicle.

In another aspect, a vehicle is provided. The vehicle comprises a driving mode selection unit and a plurality of driving modes, each mode being selectable by the driver, comprising a first driving mode and a second driving mode, wherein the first driving mode comprises a first motor torque command curve profile, a first regenerative braking profile, a first electronic power steering profile, a first electronic stability control profile, and a first antilock braking profile, and a first top speed, wherein the second driving mode comprises a second motor torque command curve profile, a second regenerative braking profile, a second electronic power steering profile, a second electronic stability control profile, and a second antilock braking profile, and a second top speed, wherein at to least three of the first profiles are different from the corresponding second profiles.

Other advantages and novel features will become apparent from the following detailed description of various non-limiting embodiments when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow understanding by those of ordinary skill in the art. In the figures:

FIG. 1A shows a flowchart, according to an embodiment;

FIG. 1B shows a matrix of driving modes and vehicle subsystem profiles, according to an embodiment;

FIG. 2 shows a driving mode selection unit, according to an embodiment;

FIG. 3 shows a plot of motor torque profiles, according to an embodiment;

FIG. 4 shows a plot of motor torque profiles, according to another embodiment;

FIG. 5 shows a plot of motor torque profiles at various regenerative braking levels, according to an embodiment;

FIG. 6 shows a plot of motor torque profiles at various regenerative braking levels, according to another embodiment;

FIG. 7 shows a plot of motor torque profiles as a function of user braking input at various regenerative braking levels, according to an embodiment; and

FIG. 8 shows a plot of motor torque profiles as a function of user braking input at various regenerative braking levels, according to another embodiment.

### DETAILED DESCRIPTION

Electric vehicle driving modes and methods of use thereof are described. In one aspect, a vehicle includes a driving mode selection unit. The driving mode selection unit can be used to select a particular driving mode from amongst a plurality of driving modes. In some embodiments, a first driving mode may allow greater acceleration than a second driving mode. In some embodiments, a vehicle may be capable of using more energy in a first driving mode than in a second driving mode. A driving mode may comprise one or more profiles comprising a motor torque curve (i.e., acceleration) profile, a regenerative braking level profile, an electronic power steering profile, an electronic stability control profile, an antilock braking system profile, and/or a top speed profile. In one embodiment, when a user selects a desired mode, three or more of these (or other) profiles are implemented.

Generally, vehicles are manufactured for specific purposes. For example, a sports car may be designed for performance with respect to properties such as acceleration and handling. In another example, a commuter car may be designed for economy (i.e., energy efficiency). Generally, energy efficiency is sacrificed for performance and vice versa. However, by including a driving mode selection unit, a driver may select a driving mode that corresponds to the style of driving the driver may wish to have. For instance, a driver may select an economy mode when commuting, when in traffic (e.g., “stop and go” traffic), or when the vehicle is low on energy. In another non-limiting example, a driver may select a sport mode for general driving pleasure.

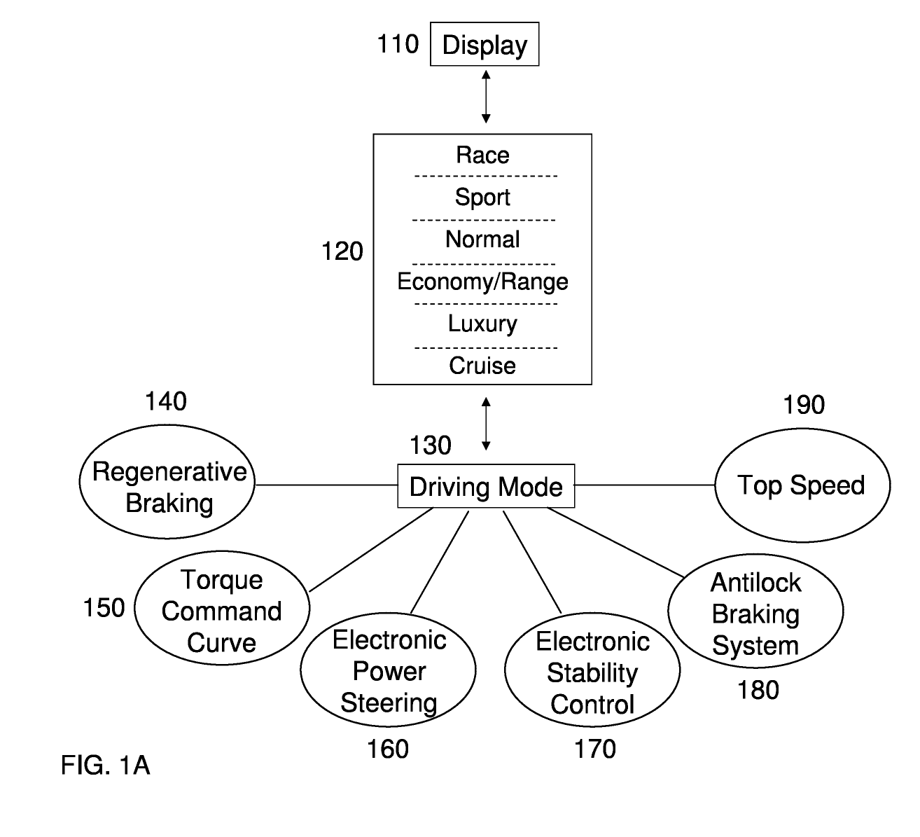

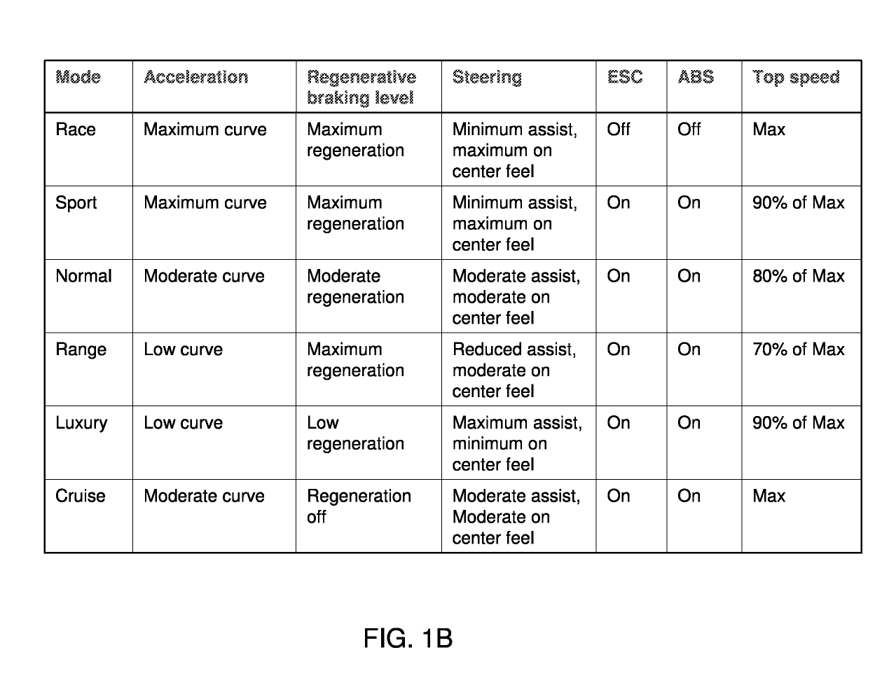

Generally, a driving mode includes one or more profiles. For example, a driving mode may include an electric motor torque command curve profile, a regenerative braking level profile, an electronic power steering profile, an electronic stability control profile, an antilock braking system profile, and/or a top speed profile. FIG. 1A shows one non-limiting embodiment of the relationship between profiles and driving mode selection unit. In FIG. 1A, a driving mode selection unit 120 may be used to select a driving mode from a list of driving modes (i.e., “race,” “sport,” “normal,” “economy/range,” “luxury,” and “cruise”). The selected driving mode may be displayed on display 110, which in some embodiments, may be integrated with the driving mode selection unit. The driving mode 130 may comprise a plurality of profiles such as a regenerative braking level profile 140, an electric motor torque command curve profile 150, an electronic power steering profile 160, an electronic stability control profile 170, an antilock braking system profile 180, and/or top speed profile 190. A profile may be the same or different in a first driving mode as compared to a second driving mode. However, generally, a first driving mode and a second driving mode differ with respect to at least one profile, and in one embodiment, differ with respect to at least three profiles.

FIG. 1B shows a matrix of various driving modes and exemplary vehicle sub-system profiles.

As discussed in more detail below, in some embodiments, a profile may be altered to allow a vehicle to be more energy efficient. In other embodiments, a profile may be altered to allow a vehicle to be less energy efficient yet be capable of higher performance (e.g., faster acceleration, more responsive handling, etc.). A profile may be the same or different for a first driving mode and a second driving mode and/or additional driving modes (i.e., third, fourth, etc.).

In some embodiments, a driving mode comprises an electric motor torque command curve profile (also referred to as “acceleration”). In some embodiments, the electric motor torque command curve profile may be configured to maximize energy efficiency. In other embodiments, the electric motor torque command curve profile may be configured to maximize vehicle performance. Of course, the electric motor torque command curve profile may be configured to allow vehicle operation in an intermediate range between maximum energy efficiency and maximum vehicle performance. Without wishing to be bound by any theory, an electric motor generally can operate at essentially peak torque at low RPM, e.g., at less than 1000 RPM and/or at less than 100 RPM. In some cases, the electric motor can maintain essentially peak torque at greater than 3000 RPM, at greater than 4000 RPM, at greater than 5000 RPM, or at greater than 7000 RPM. In some embodiments, the motor torque may decrease above a threshold RPM value. For instance, the threshold RPM value above which the motor torque decreases may be greater than 4000 RPM, greater than 5000 RPM, greater than 7000 RPM, or greater than 10000 RPM. The motor torque command curve may have essentially any shape. In some embodiments, the curve may be essentially linear within a range. For example, the curve may be linear within the range of 100 RPM to 5000 RPM, linear within the range of 1000 RPM to 4000 RPM, or linear within the range of 100 RPM to 2000 RPM. In some embodiments, the electric motor torque command curve profile can be configured to be aggressive (e.g., “max curve”), moderate, or limited (e.g., “low curve”).

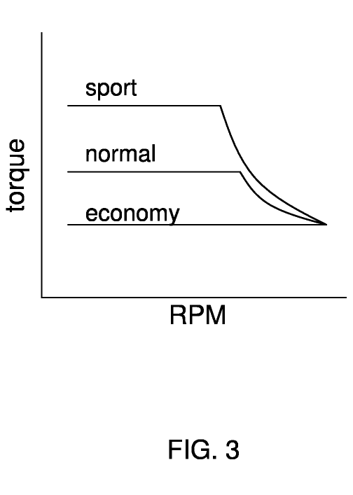

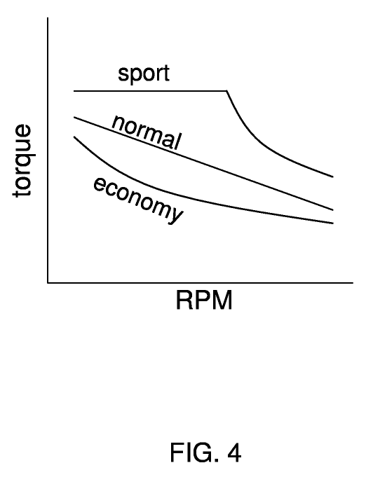

FIGS. 3 and 4 show examples according to various embodiments of motor torque profiles. In FIG. 3, torque versus motor speed for three different driving modes are shown where at low speeds, the motor torque in the sport mode is greater than the motor torque in normal mode, which is greater than motor torque in economy mode. At high motor speeds, the torque for the various modes converge, where in the normal and sport modes, the torque non-linearly tapers to a reduced torque. In the embodiment shown, in the economy mode, the torque is constant over motor speed. In FIG. 4, torque versus motor speed for three different driving modes are shown where at low speeds, the motor torque in the sport mode is greater than the motor torque in normal mode, which is greater than motor torque in economy mode. At high motor speeds, the torque for the various modes is lower than at low motor speeds. In this embodiment, the torque in the sport mode is linear over a range of motor speeds and decreases non-linearly at high motor speeds. Also in this embodiment, the torque in the normal mode decreases essentially linearly over a range of motor speeds, and the torque in the economy mode decreases non-linearly.

In some embodiments, the vehicle may be configured with a regenerative braking system, and a driving mode may comprise a regenerative braking level profile. Generally, a regenerative braking system can be activated when a user applies the brakes of a vehicle and/or when the user decreases the throttle (e.g., “coasts”). Operation of the regenerative braking system may recover energy from the kinetic energy of the vehicle for use in charging the energy storage unit of a vehicle. In some embodiments, it may be desirable to employ a different level of regenerative braking for different driving modes. For example, to improve the vehicle energy efficiency, a driving mode may comprise an aggressive regenerative braking level profile, such as in economy (i.e., range) mode (see, for example, FIG. 1B). By contrast, to improve the performance of the vehicle, it may, in some embodiments, be desirable to select a driving mode comprising a low regenerative braking level profile, such as in luxury mode (see, e.g., FIG. 1B). For instance, a moderate regenerative braking level may provide a user with more control over vehicle braking.

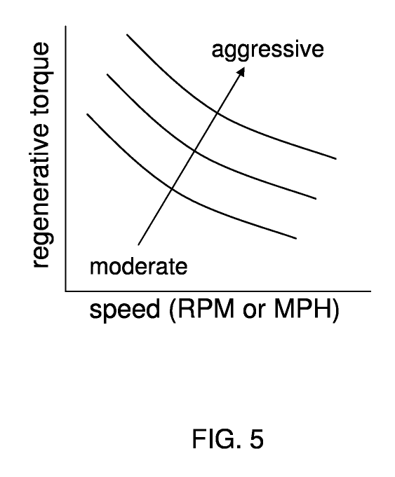

In the embodiment of FIG. 5, increased maximum regenerative power is shown (i.e., the upper curve showing a greater regenerative power than the lower curves), with the curves showing regenerative torque versus speed for various constant power lines. Here, as motor speed decreases, regenerative torque increases for any of the given power curves. Additionally, as regenerative braking power moves from moderate to aggressive over the power curves, more regenerative torque is produced at a given motor speed. As used herein, “regenerative torque” refers to the torque turning the motor when acting as an electricity generator.

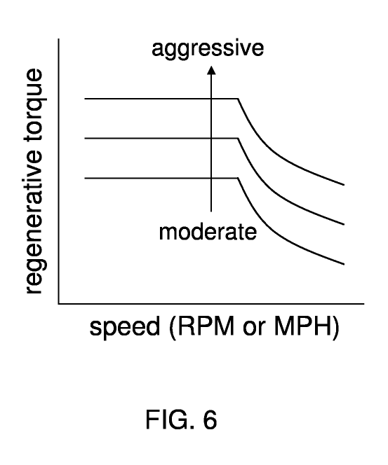

In the embodiment of FIG. 6, increasing maximum regenerative torque limit is shown, with a curve showing regenerative torque limit versus speed. In this embodiment, the regenerative torque remains essentially constant over a range of speeds regardless of regenerative braking level profile. The torque decreases non-linearly at high speeds, as above in FIG. 5.

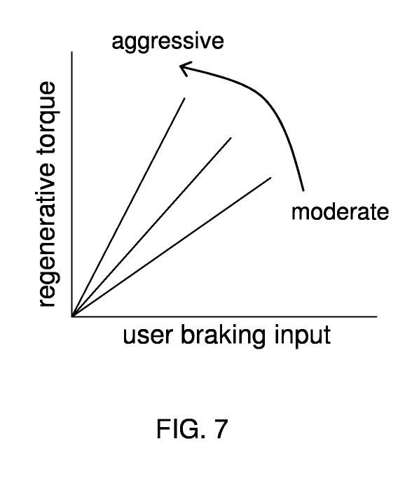

In the embodiment of FIG. 7, the effect of user braking input on regenerative torque is shown. In this embodiment, increasing regenerative braking level yields a steeper slope, which corresponds to increasing regenerative torque for a given level of user braking input. Thus, the greater the braking input (as detected by known methods), the greater the regenerative torque for a given level of regenerative braking characteristic (i.e., moderate or aggressive).

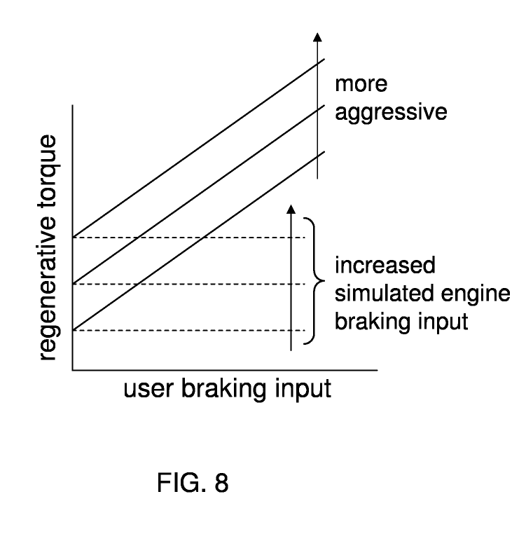

In the embodiment of FIG. 8, the effect of user braking input on regenerative torque is shown. In this embodiment, increasing regenerative braking level yields a higher intercept for the regenerative braking level slope, which corresponds to increasing simulated engine braking input for a given level of user braking input. That is, with no user braking input, regenerative braking still occurs in this embodiment, which simulates, for example, an engine braking effect from an internal combustion engine. The more aggressive the regenerative braking level, the greater the regenerative torque for a given simulated engine braking input.

In some embodiments, the vehicle may be configured with an electronic power steering system, and a driving mode may comprise an electronic power steering profile. In some embodiments, the electronic power steering profile may be configured for vehicle performance by providing increased road feedback to a user. For example, a wheeled vehicle may roll over surface terrain (e.g., road bumps and/or holes), and at least some of the force generated on the wheels of the vehicle may be translated into a steering wheel force. In so doing, a user may have a heightened awareness of road conditions. In some cases, the electronic power steering profile may contribute to increased “on center feel” by the user. As used herein, “on center feel” refers to the tendency of the steering wheel to return to center during a turn. “On center feel” also refers to the tendency of the steering wheel to remain centered when the vehicle is moving straight. Additionally, an electronic power steering profile configured for vehicle performance may provide increased power steering assist such that a user can manipulate the vehicle more easily.

Active power steering, as just described, may allow higher vehicle performance at the expense of energy efficiency; thus, if a user wishes to operate the vehicle in a more energy efficient manner, a driving mode may be selected where electronic power steering is less active. For instance, a vehicle operating in an economy mode may have an electronic power steering profile that operates with minimum power assist. As used herein, “power assist” refers to the ratio of turning effort supplied by the electronic power steering system to the effort supplied by the driver in turning the steering wheel. It should be understood that an electronic power steering profile may be chosen that is intermediate relative to the sport mode and the economy mode. In some embodiments, the electronic power steering profile for an intermediate driving mode (e.g., normal mode) may be based on average user preference. In some embodiments, the electronic power steering may positively or negatively correlate with vehicle speed. In some embodiments, the electronic power steering may positively or negatively correlate with steering wheel angle. It should be understood that the relationship between electronic power steering and another property, such as vehicle speed or steering wheel angle, can be linear or non-linear.

In some embodiments, a driving mode may comprise an electronic stability control profile. Generally, an electronic stability control system can vary the braking and/or acceleration of one or more wheels on the vehicle. In some cases, the electronic stability control can reduce the probability of a user losing control of a vehicle, for example, when turning sharply and/or operating the vehicle in conditions that reduce the traction of the vehicle. The level of electronic stability control may be programmed to correspond to a driving mode. For example, it may be desirable for a vehicle to have increased electronic stability control when operating in the sport mode. In some embodiments, increasing the electronic stability control results in higher energy consumption by the electronic stability control system, which, in some cases, results in reduced vehicle energy efficiency. In some embodiments, a vehicle operating in the economy mode may operate with reduced electronic stability control, which can contribute to higher vehicle energy efficiency.

In some embodiments, a driving mode may comprise an antilock braking system profile. Generally, an antilock braking system can vary the braking of one or more wheels on the vehicle. In some cases, the antilock braking system can reduce the probability of a vehicle wheel locking, i.e., slipping, for example, when applying the brakes suddenly and/or with high force such that one or more wheels have reduced traction. The level of antilock braking may be programmed to correspond to a driving mode. For example, it may be desirable for a driver to have more control over the braking system of a vehicle when operating the vehicle in the sport mode.

In some embodiments, the top speed of a vehicle may be limited by the driving mode. For example, in some cases the top speed may be electronically limited. In some embodiments, the top speed of a vehicle when a driving mode is selected may be 100% of the maximum top speed, at least 90% of the maximum top speed, at least 80% of the maximum top speed, at least 70% of the maximum top speed, at least 60% of the maximum top speed, or at least 50% of the maximum top speed. It should be understood that top speeds outside these ranges may be used as well.

In some embodiments, two or more profiles may be matched to each other. In some cases, a first system and a second system may be at least partially dependent on each other. For instance, the electronic stability control system and antilock braking system both can limit the probability of a vehicle wheel slipping. In some cases, operating both of these systems at a high level may increase vehicle performance, whereas operating one system at a high level and the other system at a low level may result in a negligible effect on vehicle performance. In other cases, operating both systems at a high level may result in redundancy that has a negligible effect on vehicle performance and results in poorer energy efficiency. Thus, in some embodiments, it may to be advantageous for a driving mode to have two or more profiles matched to each other for essentially optimum operation within a driving mode since this can increase energy efficiency and/or performance. One or ordinary skill in the art would be able to match two or more profiles through routine experimentation.

In one embodiment, three or more of the following vehicle systems/characteristics are adjusted simultaneously for a given driving mode: acceleration, regeneration level/feel, steering assist level/feel, electronic stability control, antilock braking system operation, and top speed.

In some embodiments, a vehicle includes logic that can calculate various statistics (e.g., the vehicle may include a trip computer). In some cases, the statistics may be used to optimize vehicle operation (e.g., vehicle performance and/or energy efficiency). In some cases, the statistics may be used by the vehicle without informing the user. In other cases, the statistics may be displayed to the user. This may be advantageous, in some embodiments, because it can provide the user with information that can allow the user to adjust the operating style of the user. For instance, a vehicle may calculate and display an energy efficiency value. In some embodiments, a user may adjust their driving style in response to the energy efficiency value to increase energy efficiency (e.g., by accelerating the vehicle at a slower rate, operating the vehicle at a slower speed, etc.). In some embodiments, a vehicle may calculate a carbon footprint score, a post-drive carbon footprint report, the cost per unit distance (e.g., mile) traveled by the vehicle, the energy used per unit distance traveled by the vehicle, and/or the amount of a fuel that would have been consumed per unit distance traveled by the vehicle. In some embodiments, the vehicle can display a comparison of one or more of these values for a current trip and one or more trips preceding the current trip. For example, the vehicle may display a comparison between the current trip and three or more trips immediately preceding the current trip.

In some embodiments, a vehicle may calculate a carbon footprint score. The carbon footprint score may correspond to the amount of carbon that has or will be released to the atmosphere by operating the vehicle. For example, an electric vehicle may be charged by plugging the vehicle into an electrical outlet. The electricity consumed by the electric vehicle may be generated by a process that released carbon to the atmosphere. For example, the electricity may have been generated by a coal-fired power plant. Each unit of electricity may thus correspond to a unit of carbon released to the atmosphere. In some cases, a vehicle may contain logic that computes the energy used by the vehicle and then multiplies the amount of energy used by a conversion factor that converts the value corresponding to the amount or energy used to a value corresponding to the amount of carbon dioxide released to the environment. In some cases, the conversion factor may be preprogrammed, i.e., by the vehicle manufacturer. In some cases, a user may input the conversion factor. For instance, if the amount of carbon released to generate each unit of electricity used by the vehicle decreases, a user may update the conversion factor so that the vehicle displays a more accurate carbon footprint score. In some embodiments, the carbon footprint score is updated and displayed essentially instantaneously. In some embodiments, a carbon footprint score may be calculated for a trip and displayed in a post-drive carbon footprint report.

In some embodiments, the vehicle may calculate a value per unit distance traveled by the vehicle, as discussed above. In some embodiments, the value per unit distance traveled by the vehicle may be reported as an essentially instantaneous value. In other embodiments, the value per unit distance traveled by the vehicle may be reported as an average value, for example, since the vehicle was last charged or since a point decided by the user (e.g., resetting of the trip odometer).

In some embodiments, the cost per unit distance traveled by the vehicle may be calculated. In some embodiments, the cost per unit of energy used by the vehicle may be inputted by the user. For example, if the vehicle is powered by electricity obtained from an electrical outlet, the cost of the electricity per unit (e.g., cents per kWhr) may be inputted and used by the vehicle to calculate the cost per unit distance traveled by the vehicle.

In some embodiments, the energy per unit distance traveled by the vehicle may be calculated. For example, the vehicle may calculate the instantaneous rate of energy usage per unit traveled and report this value. In another embodiment, the vehicle may calculate the average rate of energy usage per unit traveled.

In some embodiments, an estimated vehicle range (i.e., the remaining distance that the vehicle can travel before needing to be recharged) may be calculated and displayed. The calculation may, in some embodiments, be a function of the energy usage to per unit distance traveled and the remaining battery charge. In some cases, the estimated vehicle range can be updated and displayed when a different driving mode is selected. For example, the vehicle may calculate and display a first estimated vehicle range when operating in the sport mode and, upon selecting the economy mode, calculate and display a second updated estimated vehicle range. In some embodiments, the updated estimated vehicle range can be displayed essentially instantaneously.

In some embodiments, it may be desirable for an electric vehicle to display a value corresponding to the amount of a fuel (e.g., gasoline) that would have been consumed per unit distance traveled by the vehicle if the vehicle were powered by the fuel. This value may, in some embodiments, be calculated by determining the amount of energy consumed by the vehicle per unit distance traveled and multiplying this value by a conversion factor corresponding to an amount of fuel per unit energy. One of ordinary skill in the art would recognize that the energy content of fuels can vary depending on the composition of the fuel. For example, gasoline may have more energy content per unit volume than ethanol. Thus, in some cases, the vehicle may display multiple values corresponding to the amount of various fuels that would have been consumed per unit distance traveled by the vehicle if the vehicle were powered by the various fuels.

Generally, the driving mode selection unit may be used in any vehicle having an electrical power system for propelling the vehicle. For example, the vehicle may be a wheeled vehicle having one or more wheels, i.e., a vehicle that can be ridden or driven on a surface, where the one or more wheels are in contact with the surface, such as a passenger vehicle. The vehicle may be an electric vehicle, i.e., a vehicle propelled by one or more battery-operated electric motors.

A vehicle containing an electric motor may be powered, in some embodiments, by one or more energy storage units (e.g., batteries). Any suitable battery may be used. Non-limiting examples of batteries include batteries comprising nickel (e.g., nickel-metal hydride, nickel cadmium, etc.), zinc (e.g., nickel-zinc), and/or lithium (e.g., lithium ion). Those of ordinary skill in the art will be able to select batteries comprising other elements.

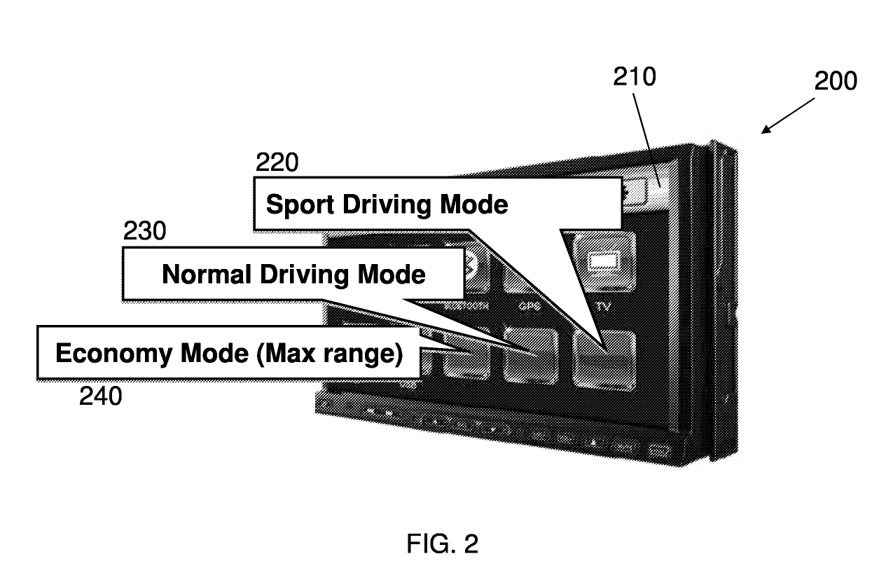

In one aspect, the vehicle may include a driving mode selection unit. Generally, the driving mode selection unit may be used to select a particular driving mode from amongst a plurality of driving modes. For example, the plurality of driving mode may include at least two driving modes, at least three driving modes, at least four driving modes, or even more. FIG. 2 shows one non-limiting embodiment of a driving mode selection unit 200. The driving mode selection unit shown in FIG. 2 comprises a touchscreen 210 and buttons 220, 230, and 240 for selecting a driving mode. The driving mode selection unit may also comprise additional buttons for performing other functions that may or may not be related to driving mode selection. For example, as shown in FIG. 2 the driving mode selection unit may include buttons for activating a television (i.e., TV), global positioning system (i.e., GPS), Bluetooth®, and/or a universal serial bus (i.e., USB).

The driving mode selection unit may comprise any suitable interface for selecting the driving mode. In some embodiments, the driving mode selection unit may include one or more buttons for selecting a driving mode. In some cases, the buttons may be depressed by a user (e.g., actuated) to select a driving mode. In other embodiments, the buttons for selecting a driving mode may be displayed as objects on a touchscreen.

In some cases, the driving mode selection unit may have a single button that may be pressed by a user to change the driving mode. For example, a user may press the single button to cycle through a group of driving modes in order to select a driving mode, i.e., pressing the single button changes the driving mode from a first driving mode to a second driving mode. In another embodiment, the driving mode selection unit may have two or more buttons. For example, the driving mode selection unit may have a first button that may be used to scroll through a list of driving modes, where each press of the first button “highlights” the next driving mode in the list of driving modes, and a second button that may be used to select the highlighted driving mode. In yet another embodiment, the driving mode selection unit may have two or more buttons, where each button corresponds to a different driving mode that can be selected by pressing the button corresponding to the desired driving mode. In some embodiments, a button corresponding to a particular driving mode may be illuminated when that driving mode is selected. In some embodiments, the illumination level between two or more buttons may indicate the currently selected driving mode. For example, the button corresponding to the currently selected driving mode may be more or less illuminated than the other driving mode selection buttons. In some cases, the selected driving mode may be indicated by color. For example, a single driving mode selection button may change color to indicate the currently selected driving mode. In some embodiments, the driving mode selection unit may have one button, two buttons, three buttons, four buttons, or even more buttons.

In some embodiments, the driving mode selection unit may be “intelligent,” where the driving mode selection unit automatically selects a driving mode based, at least in part, on the driving style of the user.

In some embodiments, a driving mode may be locked by a user. For example, in some cases, a driving mode may be password protected, biometrically protected (i.e., fingerprint, retinal scan, voice recognition, etc.), key protected, and the like. A lockable driving mode may be desirable, for example, for limiting the vehicle performance under certain conditions. For example, a parent may desire to limit the level of vehicle performance when loaning the car to a child. In another example, a user may wish to limit the level of vehicle performance when a valet is using the vehicle. In yet another example, it may be desirable to limit vehicle performance for a shared car (i.e., a rental vehicle or fleet vehicle).

In some embodiments, a vehicle may have at least two driving modes. For example, a vehicle may have a sport mode and an economy mode. In some cases, the vehicle may have a third driving mode. For instance, the third driving mode may be a normal mode that is an intermediate mode relative to the sport mode and the economy mode. It should be understood that a vehicle may have a fourth, fifth, sixth, or even more driving modes. For instance, as described above, a vehicle may also have a race mode, a luxury mode, and/or a cruise mode.

In some embodiments, as shown in FIG. 1B, the race mode comprises a torque curve profile that allows for maximum acceleration. The race mode may also comprise a regenerative braking profile that allows for maximum regenerative braking. The race mode may further comprise an electronic power steering profile that provides minimum power assist and maximum on center feel. In some cases, the electronic stability control system may be inactivated in the race mode. In some instances, the antilock braking system may be inactivated in the race mode. In some embodiments, the race mode may allow 100% of the maximum vehicle top speed.

In some embodiments, the sport mode comprises a torque curve profile that allows for maximum acceleration. The sport mode may also comprise a regenerative braking profile that allows for maximum regenerative braking. The sport mode may further comprise an electronic power steering profile that provides minimum power assist and maximum on center feel. In some cases, the electronic stability control system may be activated in the sport mode. In some instances, the antilock braking system may be activated in the sport mode. In some embodiments, the sport mode may allow at least 90% of the maximum vehicle top speed.

In some embodiments, the normal mode comprises a torque curve profile that allows for moderate acceleration. The sport mode may also comprise a regenerative braking profile that allows for moderate regenerative braking. The sport mode may further comprise an electronic power steering profile that provides moderate power assist and moderate on center feel. In some cases, the electronic stability control system may be activated in the normal mode. In some instances, the antilock braking system may be activated in the normal mode. In some embodiments, the normal mode may allow at least 80% of the maximum vehicle top speed.

In some embodiments, the economy mode comprises a torque curve profile that allows for low acceleration. The economy mode may also comprise a regenerative braking profile that allows for maximum regenerative braking. The economy mode may further comprise an electronic power steering profile that provides minimum power assist and moderate on center feel. In some cases, the electronic stability control system may be activated in the economy mode. In some instances, the antilock braking system may be activated in the economy mode. In some embodiments, the economy mode may allow at least 70% of the maximum vehicle top speed.

In some embodiments, the luxury mode comprises a torque curve profile that allows for low acceleration. The luxury mode may also comprise a regenerative braking profile that allows for minimum regenerative braking. The luxury mode may further comprise an electronic power steering profile that provides maximum power assist and minimum on center feel. In some cases, the electronic stability control system may be activated in the luxury mode. In some instances, the antilock braking system may be activated in the luxury mode. In some embodiments, the luxury mode may allow at least 90% of the maximum vehicle top speed.

In some embodiments, the cruise mode comprises a torque curve profile that allows for moderate acceleration. The cruise mode may also comprise a regenerative braking profile where the regenerative braking is inactivated. The cruise mode may further comprise an electronic power steering profile that provides moderate power assist and moderate on center feel. In some cases, the electronic stability control system may be activated in the cruise mode. In some instances, the antilock braking system may be activated in the cruise mode. In some embodiments, the cruise mode may allow 100% of the maximum vehicle top speed.

In some embodiments, a driving mode may include an HVAC profile. For instance, an HVAC profile may activate a recirculation function for the cabin air. In another example, an HVAC profile may limit the use of an air conditioning compressor.

In some embodiments, a driving mode may include a suspension damping profile. In some cases, the suspension damping profile may be stiffened, for example, when driving in the race or sport mode. A stiffened suspension damping profile may, in some embodiments, provide a driver with more road feedback. In some cases, the suspension damping profile may be softened.

In some cases, a driving mode profile may control the height of a vehicle. For example, the profile may alter the suspension of the vehicle to adjust the height of the vehicle. In some cases, a lowered vehicle height may chosen when vehicle performance is desired.

In some embodiments, a driving mode profile may control the spring constant of the vehicle. The spring constant refers to the physical constant associated with the wheel springs as understood by those of ordinary skill in the art. When vehicle performance is desired, a large spring constant may be chosen to provide a stiffer feel to vehicle driving. Alternatively, a small spring constant may be chosen to provide a softer feel to vehicle driving.

In some cases, a vehicle may include at least two default driving modes. For example, the default driving modes may be factory programmed or otherwise programmed prior to receipt of the vehicle by the user. In some embodiments, one or more driving modes may be customizable. That is, a user may program a custom driving mode. In certain embodiments, a vehicle may include a default number of driving modes, and a user may program additional driving modes.

In some cases, a vehicle operating in a first driving mode may be capable of traveling at least 10% further per unit of energy consumed, at least 20% further per unit of energy consumed, at least 30% further per unit of energy consumed, at least 50% further per unit of energy consumed, or at least 100% further per unit of energy consumed than when the vehicle is operating in a second driving mode. For example, in some embodiments, a vehicle operating in the economy mode may be capable of traveling further per unit of energy consumed than a vehicle operating in a less energy efficient driving mode such as the sport mode, normal mode, or other mode. In some embodiments, the sport mode may allow maximum vehicle performance essentially independent of energy efficiency. In some cases, the economy mode may allow maximum vehicle energy efficiency essentially independent of vehicle performance. In some embodiments, the normal mode may be any mode where the vehicle performance and/or energy efficiency is intermediate relative to the economy mode and the sport mode.

In some embodiments, a driving mode may affect the handling of a vehicle. As used herein, “handling” refers to the performance of vehicle transverse to the direction of motion (i.e., when, for example, cornering and/or swerving) and the stability of the vehicle when moving in an essentially straight line. A variety of factors may influence the handling of a vehicle. For instance, the weight distribution of the vehicle, the suspension, the tires and wheels, the track and wheelbase, the weight of the vehicle, aerodynamics, delivery of power to the wheels, delivery of power to the brakes, steering, electronic stability control, static alignment of the wheels, and/or rigidity of the frame. The handling may be characterized by properties such as maximum g-force capability in a turn, under steer and/or over steer. In some embodiments, these properties may be affected by the electronic stability control.

In some embodiments, a vehicle operating in a first driving mode may be capable of accelerating at least 10% faster, at least 20% faster, at least 30% faster, at least 50% faster, or at least 100% faster than when the vehicle is operating in a second driving mode. For example, a vehicle operating in the normal mode or sport mode may by capable of accelerating faster than when the vehicle is operating in the economy mode.

U.S. Provisional Patent Application No. 61/334,441, filed May 13, 2010, and entitled “Selectable Driving Modes” is incorporated herein by reference in its entirety for all purposes.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, the embodiments may be practiced otherwise than as specifically described and claimed. Aspects directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A vehicle, comprising:
a driving mode selection unit; and
a plurality of driving modes, each associated with at least three vehicle system operating profiles, wherein:
a driving mode is operable based on input from the driving mode selection unit, and
each of the at least three vehicle system operating profiles comprises one of a torque command curve, regeneration braking level, steering assist level, stability control operation, antilock braking operation, and top speed of the vehicle.

2. The vehicle of claim 1, wherein the driving mode selection unit is manually selectable to select a driving mode.

3. The vehicle of claim 1, wherein the driving mode selection unit is automatically able to select a driving mode.

4. The vehicle of claim 1, further comprising a first driving mode and a second driving mode, wherein the first driving mode comprises a first electronic power steering profile and the second driving mode comprises a second electronic power steering profile, the first electronic power steering profile being different from the second electronic power steering profile.

5. The vehicle of claim 1, further comprising a first driving mode and a second driving mode, wherein the at least three operating profiles of the first driving mode are different from a corresponding three operating profiles of the second driving mode.

6. The vehicle of claim 1, wherein the vehicle is capable of achieving a substantially higher rate of acceleration when operating in a first driving mode in comparison to operating in a second driving mode.

7. The vehicle of claim 4, further comprising a third driving mode, wherein the third driving mode comprises a third electronic power steering profile, wherein the third electronic power steering profile is different from the first electronic power steering profile and the second electronic power steering profile.

8. The vehicle of claim 7, wherein the third electronic power steering profile is based on average driver preference.

9. The vehicle of claim 4, wherein the first electronic power steering profile is configured for road feedback and increased on center feel.

10. The vehicle of claim 4, wherein the second electronic power steering profile is based on minimum power assist.

11. The vehicle of claim 1, further comprising a first driving mode comprising a first motor torque command curve profile and a second driving mode comprising a second motor torque command curve profile, wherein the first motor torque command curve profile is different from the second motor torque command curve profile.

12. The vehicle of claim 1, further comprising a first driving mode comprising a first regenerative braking profile and a second driving mode comprising a second regenerative braking profile, wherein the first regenerative braking profile is different from the second regenerative braking profile.

13. The vehicle of claim 1, further comprising a first driving mode comprising a first antilock braking system profile and a second driving mode comprising a second antilock braking system profile, wherein the first antilock braking system profile is different from the second antilock braking system profile.

14. The vehicle of claim 1, further comprising a first driving mode comprising a first HVAC profile and a second driving mode comprising a second HVAC profile, wherein the first HVAC profile is different from the second HVAC profile.

15. The vehicle of claim 1, further comprising a first driving mode comprising a first suspension damping profile and a second driving mode comprising a second suspension damping profile, wherein the first suspension damping profile is different from the second suspension damping profile.

16. The vehicle of claim 1, further comprising a first driving mode comprising a first ride height profile and a second driving mode comprising a second ride height profile, wherein the first ride height profile is different from the second ride height profile.

17. The vehicle of claim 1, further comprising a first driving mode comprising a first spring constant profile and a second driving mode comprising a second spring constant profile, wherein the first spring constant profile is different from the second spring constant profile.

18. The vehicle of claim 1, further comprising logic that calculates a carbon footprint calculation for a period of operation of the vehicle and a display for displaying the carbon footprint calculation.

19. The vehicle of claim 18, wherein the carbon footprint calculation is expressed as a numerical score.

20. The vehicle of claim 1, further comprising logic that calculates an average cost per mile driven.

21. The vehicle of claim 1, further comprising logic that calculates an essentially instantaneous cost per mile driven.

22. The vehicle of claim 1, further comprising logic that calculates a value corresponding to the average amount of energy used per mile driven.

23. The vehicle of claim 22, wherein the value corresponding to the average amount of energy used per mile driven is converted to a value corresponding to an amount of petroleum-based fuel that would have been consumed by an internal combustion engine to power the vehicle.

24. The vehicle of claim 1, further comprising logic that calculates an essentially instantaneous amount of energy used per mile driven.

25. The vehicle of claim 1, further comprising a first driving mode and a second driving mode, wherein the first driving mode comprises a first electronic power steering profile and a first electric motor torque command curve and the second driving mode comprises a second electronic power steering profile and a second electric motor torque command curve, wherein the first electronic power steering profile is different from the second electronic power steering profile, wherein the first electric motor torque command curve is different from the second electric motor torque command curve.

26. The vehicle of claim 25, further comprising a third driving mode, wherein the third driving mode comprises a third electric motor torque command curve profile, wherein the third electric motor torque command curve profile is different from the first electric motor torque command curve profile and the second electric motor torque command curve profile.

27. The vehicle of claim 26, wherein the third electric motor torque command curve profile is based on average driver preference.

28. The vehicle of claim 11, wherein the first electric motor torque command curve profile is configured for aggressive driving.

29. The vehicle of claim 11, wherein the second electric motor torque command curve configured for moderate driving.

30. The vehicle of claim 1, further comprising a first driving mode and a second driving mode, wherein the first driving mode comprises a first electronic stability control profile and a first antilock braking system profile, wherein the first electronic stability control profile and the first antilock braking system profile are matched relative to each other for essentially optimal operation.

31. The vehicle of claim 30, wherein the essentially optimal operation is configured for essentially optimal vehicle performance.

32. The vehicle of claim 30, wherein the essentially optimal operation is configured for essentially optimal vehicle energy efficiency.

33. A vehicle, comprising:
a driving mode selection unit; and
a plurality of driving modes, each mode being selectable by the driver, comprising a first driving mode and a second driving mode, wherein:
the first driving mode comprises a first motor torque command curve profile, a first regenerative braking profile, a first electronic power steering profile, a first electronic stability control profile, a first antilock braking profile, and a first top speed;
the second driving mode comprises a second motor torque command curve profile, a second regenerative braking profile, a second electronic power steering profile, a second electronic stability control profile, a second antilock braking profile, and a second top speed; and
at least three of the first profiles are different from the corresponding second profiles.

34. The vehicle of claim 33, further comprising a third driving mode, wherein the third driving mode comprises a third motor torque command curve profile, a third regenerative braking profile, a third electronic power steering profile, a third electronic stability control profile, a third antilock braking profile, and a third top speed, wherein each of the third driving mode profiles are different from each of the first driving mode profiles and the second driving mode profiles.

35. The vehicle of claim 33, wherein the first motor torque command curve profile is an aggressive motor torque command curve profile.

36. The vehicle of claim 33, wherein the first regenerative braking profile is a moderate regenerative braking profile.

37. The vehicle of claim 33, wherein the first electronic power steering profile is configured for road feedback and increased on center feel.

38. The vehicle of claim 33, wherein the third motor torque command curve is a moderate motor torque command curve profile.

39. The vehicle of claim 33, wherein the third regenerative braking profile is a moderate regenerative braking profile.

40. The vehicle of claim 33, wherein the third electronic power steering profile is based on average driver preference.

41. The vehicle of claim 33, wherein the second motor torque curve is a limited motor torque command curve profile.

42. The vehicle of claim 33, wherein the second regenerative braking profile is an aggressive regenerative braking profile.

43. The vehicle of claim 33, wherein the second electronic power steering profile is based on minimum safe power assist.

44. The vehicle of claim 33, further comprising logic that calculates a carbon footprint calculation for a period of operation of the vehicle and a display for displaying the carbon footprint calculation.

45. The vehicle of claim 44, wherein the carbon footprint calculation is expressed as a numerical score.

46. The vehicle of claim 33, further comprising logic that calculates the average cost per mile driven.

47. The vehicle of claim 33, further comprising logic that calculates an essentially instantaneous cost per mile driven.

48. The vehicle of claim 33, further comprising logic that calculates a value corresponding to the average amount of energy used per mile driven.

49. The vehicle of claim 48, wherein the value corresponding to the average amount of energy used per mile driven is converted to a value corresponding to an amount of petroleum-based fuel that would have been consumed by an internal combustion engine to power the vehicle.

50. The vehicle of claim 33, further comprising logic that calculates an essentially instantaneous amount of energy used per mile driven.
